(19) United States
(12) Patent Application Publication
(10) Pub. No.: US 2025/0217780 A1
(43) Pub. Date: Jul. 3, 2025

(54) SYSTEM AND METHOD OF RECYCLING RECYCLABLE MATERIALS

(71) Applicants: Alexander YAMINE, Tulsa, OK (US); Elias YAMINE, Tulsa, OK (US)

(72) Inventors: Alexander YAMINE, Tulsa, OK (US); Elias YAMINE, Tulsa, OK (US)

(21) Appl. No.: 18/850,876

(22) PCT Filed: Mar. 25, 2022
(86) PCT No.: PCT/US2022/021948

§ 371 Date: Sep. 25, 2024

(51) Int. Cl. G06Q 10/30; G06Q 10/0833; G06Q 50/00

(52) U.S. Cl. CPC G06Q 10/30; G06Q 50/01; G06Q 10/0833

(57) ABSTRACT

A process containing an efficient electronic and network enhanced recycling system which moves consumer recyclable elements which are discarded by a first individual and/or plurality of individual recycling participants to a respective plurality of electronically enhanced homogeneous one time use containers which when full, are individually discarded at a collection point in which said homogeneous containers are congregated in larger, electronically enhanced poly containment element whereby said electronic enhancement component notifies recyclable collection agency logistics of location, genre and weight. Once said recycling collector unit has picked up all of the homogeneous waste, it is taken to a recycling plant and each said electronically enhanced homogeneous recycling container is scanned for sorting and processing by useable and non-useable recycling materials after which said materials are processed, said first individual recycling participant is notified via network user interface of their participation efforts and given a reward.

### FIELD OF INVENTION

This description relates generally to recycling but more particularly to an app which efficiently guides every participant through every step from discarding recyclable waste to, sorting homogeneous tagged bags into respective recyclable waste containers to logistics for pickup and delivery services to processing plant that converts recyclable waste into recycled raw materials and to manufacturers who convert recycled raw materials to consumer products.

### BACKGROUND

Recycling of recyclable waste is the process of collecting, sorting and processing said recycled waste that would otherwise be thrown away as trash and turning them into new products using the recycled raw materials. Recycling has many benefits to both the community and the environment. Conventional recycling offers isolated elements used in the recycling process to recycling participants used in a 3 cycle process. Collecting and processing the recycled waste, manufacturing with the processed recycled raw material created by the said recycled waste and finally selling the newly manufactured consumer goods in an open market where the recycled products may be used again.

In order for a city to have an effective recycling system, adequate services (like separate bins and safe recycling centers) are needed. Some cities just don't have these resources or the government support to have adequate recycling services for willing user/participants. Recycling is playing a role in solving the toxic plastic waste issues that is plaguing our waterways and oceans. Most challenges to recycling can be alleviated if user/participants buy more products that are made from recycled materials. Users need to educate themselves on what goes into the recycling bin and work harder to make sure that recyclable materials don't end up in a landfill somewhere when they can be reused over and over again.

Recycling needs to be done efficiently and the current recycling system being used today is showing some mixed results, especially as countries continue to export contaminated recyclables to countries that lack adequate infrastructure and proper recycling hardware to efficiently process said recycling waste. Recycling raw materials produces its strongest benefits when it displaces the extraction of materials (like ore or oil) at the beginning of the production process. Right now current augmentation of recycled raw material is used to supplement virgin resources rather than virgin resources used to supplement recycled raw material. The objective is to reverse this augmentation process where the recycled raw materials are used more than the virgin resources.

Recycling is done poorly in different countries mostly because the average public is confused about what and how to recycle. You can look in most recycle bins and see there are other heterogeneous waste thrown in with the wrong genre' of waste respective to the waste container. This places too much work load on the collectors who now have to manually and painstakingly sort the heterogeneous mix of recyclable waste into a homogeneous recyclable waste for processing. This contamination of mixing recyclable waste leads to increased costs for the sorting and processing plants, the ones who pay for recycled consumer products, and any governments who collect recyclable waste. The user/participants who buy recycled consumer products and most governments are subsidizing both the companies that produce the materials and those that purchase them after recycling. This contributes to problems in the recycling industry.

Therefore there is a need for a better way to recycle recyclable waste using electronically enhanced hardware, social networking and relational database to connect areas of problems and streamline the recycling process to an efficient cycle that follows the recycled discarded waste from use/participant drop off at a pre-sorting location to logistics for efficient pickup and delivery to processing of recycled raw material to selling on a market to manufacturers who can easily access the purchase of said recycled raw materials for their manufacturing process to deliver newly created recycled consumer goods to an open trade market.

It will become apparent in this application that sufficient description has been given and other modifications could be made without departing from the scope or spirit of the art.

Finally, the reference is made to U.S. patents applications Ser. Nos. 16/258,129 (“METHODS OF MATRIX ASSISTED INTELLIGENT RECYCLING CHUTE SELECTOR DEVICES”) and 16/925,450 (“METHODS OF RECYCLABLE ELECTRONIC BASED REWARD SYSTEM FOR INVOKING PROPER RECYCLING PROCEDURES”) that describe the state of the related art.

### SUMMARY OF THE INVENTION

In one aspect of the present invention, a process by which each user/participant in a relational database driven social media mobile application is led step by step from the beginning journey of the deposited recyclable waste to the recycled consumer product in an open trade market. A user/participant may be defined as a person who is involved in any step of the process in the cycle of recycling.

The application contains user interfaces that interface user/participants, recycling hardware, firmware and software components that aid in the process of recycling. The proposed system utilizes a digital network interface that monitors and controls a series of processes to complete a recycling life cycle efficiently whereby each process is controlled, monitored and logged by a network user interface to aid in the assurance of completion and monitoring of each task where each process is attributed to a final efficient outcome converting recyclable materials to raw materials which enter back into the production cycle of new materials. The overall goal is to utilize user/participants to participate in recycling of unsustainable virgin materials which will be replaced with sustainable recyclable materials rather than augmenting sustainable recyclable materials with unsustainable virgin materials to create new consumer goods.

A sheet of paper comes from trees and is processed with chemicals and other elements that create a consumer product of paper goods. These are sold in a market to consumers who use this paper and when discarded is placed in an electronic RFID or QR code enhanced homogenous container with other paper byproducts. When this container of electronic RFID or QR code enhanced homogenous paper recyclable product is full, it is then required to join other electronic RFID or QR code enhanced homogenous paper recyclable products being discarded by other consumers. In this proposed art, we provide a collection point for the user/participant to dispose of homogenous recyclable materials by choosing respective selections corresponding to their recyclable waste on a user interface which presorts the recycling waste deposits in a larger container with other of the same homogenous recyclable materials that have been discarded by other user participants.

The process of the recycling app connects to an efficient electronic and network enhanced recycling system which moves consumer recyclable elements which are discarded by a first individual and/or plurality of individual recycling participants to a respective plurality of electronically enhanced homogenous one time use containers which when full, are individually discarded at a collection point in which said homogenous containers are congregated in larger electronically enhanced poly containment element whereby said electronic enhancement component notifies recyclable collection logistics component of the app of location, genre' and weight. The recyclable collection logistics agency then generates a routing map of geolocations of a plurality of homogenous recyclable materials and sends geo information routing to a recycling collector unit via network. The said homogenous waste in poly containment element is picked up by said recycling collector unit which was notified by said recyclable logistics collection component of the app that tracks said recycling collector unit via means of geolocation, geofencing and RFID which updates a database of said geo data elements for future logistics and efficiency analysis. Once said recycling collector unit has picked up all of the homogenous waste, it is taken to a recycling plant and each said electronically enhanced homogenous recycling container is scanned for sorting and processing by useable and non-useable recycling materials after which said materials are processed, said first individual recycling participant is notified via network user interface of their participation efforts and given a reward. Said useable homogenous recyclable materials are then processed and ready for market use whereby said useable homogenous recycling raw materials are placed in a digital bidding auction for companies to purchase through a network user interface.

### BRIEF DESCRIPTION OF THE DRAWINGS

FIG. 1 is a flow diagram cycle of user/participant logic of the recycling app.

FIG. 2 is a flow diagram cycle of a collection sorting system which reports bin capacity information and user/participant usage to a relational database and shares said info on an app.

FIG. 3 is a collections and logistics flow diagram cycle showing bin capacity reporting to the app, geolocation and homogeneous and heterogeneous genre' of recyclable waste.

FIG. 4 is a homogeneous and heterogeneous recycling plant flow diagram cycle that shows reception of recyclable waste, notifies user/participants of receiving said waste and converts said waste into reusable recycled raw material.

FIG. 5 is Shows a recycling store flow diagram cycle where homogeneous recycled raw materials are posted to a network for sale and purchased through the recycling store.

FIG. 6 is a logical flow diagram cycle of a recycling raw material buyer and how the recycled raw materials move from the seller to the buyer.

FIG. 7 is a market flow diagram cycle where products produced by the buyer of the recycled raw materials converts them into consumer products which are sold in the market part of the app.

FIG. 8 is a complex network showing the apps logical functions of each cycle combined to create an efficient flow from user/participant to sorter to logistics to processing plant to recycling store to buyer and back to market where products made from the homogeneous recycled raw material were converted into consumer products and sold back to the user/participants.

FIG. 9 shows a concept bag with affixed or embedded RFID tag that will be tracked through the recycling system app. Also shown in FIG. 9 is a containment element which can contain the self-supporting bags which morphologically change shape due to a coiled internal element.

FIG. 10 shows a remote collection station where bags in FIG. 9 may be placed to separate specific genre of recyclable discarded waste. There may be a plurality of these remote recycle sorters at any given location.

FIG. 11 shows a design of a sorting system containing a rotational sorter, plurality of bins, sensors sufficient to determine bin capacity, selection membrane, central controller and a floor discarding portal whereby said user/participant may make selection respective to the homogeneous recyclable waste they are discarding.

FIG. 12 shows various elements involved in the recycling notification for pickup and delivery of homogeneous recyclable materials by logistics which converts geolocation, homogeneous recyclable waste and possible weight of homogeneous recycled waste containment elements. Also shown in FIG. 12 is a means for geofencing at location of homogeneous recyclable waste pickup to allow the app to show tracking events and locations of recyclable material transport elements.

FIG. 13 shows a homogeneous recyclable waste management delivery system which is delivering the tagged bags that were discarded by user/participants. Once task is completed, the logistics job is done and the app is updated of their performance.

FIG. 14 shows a system where the user discards various selections of homogeneous recyclable waste genre in tagged bags which are gravity fed to a sorting element and into a respective homogeneous recyclable waste containment element which when full, a notification to logistics picks up the homogeneous recyclable waste and delivers it to a recycling plant. Each step of the way the app records and reports information of the whereabouts of the tagged bags. Every element has an ID to help determine efficiency of the recycling system.

FIG. 15 shows a QR code or RFID element which is on the tag bags container purchased by the said user/participant along with other recycled consumer goods which are sold in the market place in the app and other consumer venues.

### DETAILED DESCRIPTION

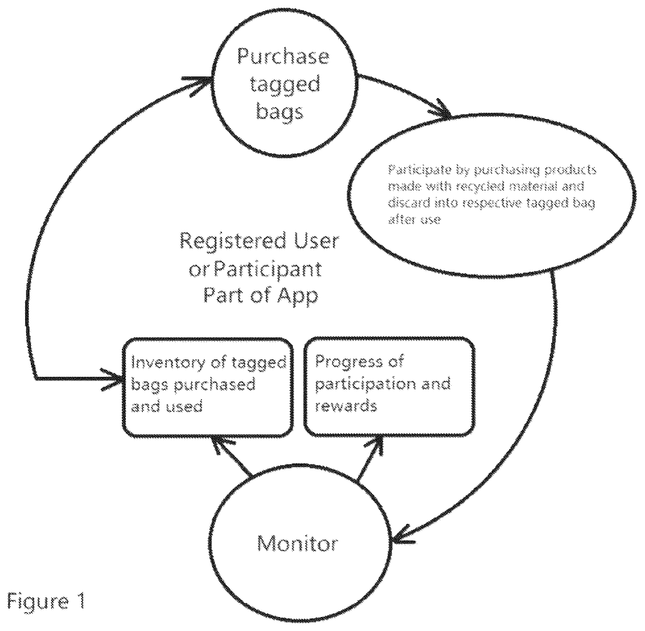

### User Participant App (FIG. 1)

The user participant component of the app is where the participants of recycling sign up for membership in the recycling community using a relational database element. This would consist of setting a Username, Password, Email address. Once signed up, the user receives confirmation verification and the account is auto-generated. Now the user is a registrant and may now edit their online profile and set up pay options for any online transactions used within the app which offers elements of recyclable goods or services. The participant may now order items such as “tagged recyclable bags” which contain RFID tags embedded in each bag. The bags may vary in color in respect to homogeneous recycled goods they will contain once participant has discarded recyclable waste in them. Each bag has a unique ID which is assigned to a group. For instance there may be 20 bags of 4 colors representing Paper, Plastic, Organic and General Waste whereby the bag container may contain a QR code element which is registered to all RFID tags within the contents of the bag. The participant may go to a part of the app and “Scan the QR Code” to register the grouping of the RFID tags whereby completion of such task, will assign the grouping of RFID tags to belong to said participant.

Now the participant may place the bags in their respective containment element where they discard the homogeneous recyclable waste. When a bag is full, the participant may now go to a “Collection Sorting” station and discard the homogeneous waste. Once discarded, they will now receive a notification in their app that the RFID scanned at the collection sorting station has recorded the transaction and the bag is removed from their inventory in their relational database account. As they discard each bag into the collection sorting station, their inventory is adjusted in their app respectively. When their inventory gets low, they may have an option to auto-renew purchase options of new bags or opt to purchase new bags manually to continue recycling participation.

After their bag has been processed at the Processing plant, they will receive notification or confirmation of their participation. Here rewards may be given such as free bags, crypto currencies or followings of other members within the app community. We recognize other reward types may be utilized as well. The user/participant may also view their participation progress where graphic user interface shows how much they participate compared to the community efforts as a whole. Options such as participation graphs and rewards will assist in coaxing each member to become more active in recycling.

Each user/participant within the recycling community app may receive news or other important information about geolocations of new collection points; fill capacity and ease of access. They may view other user's posts on experiences or recycling stories. Other elements of controlling recycling behavior in the app are the ability to fine user/participants for “lack of participation” as well. We recognize the ability to both reward and fine users/participants based on their participation respectively.

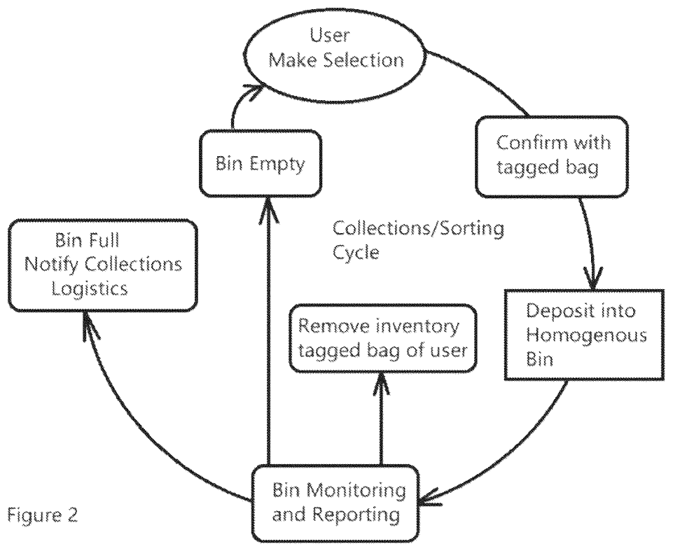

### Collections and Sorting (FIG. 2)

After a collection sorting system is installed, the location of installation will add a geolocation and added to the app as a collection point for homogeneous and heterogeneous recyclable materials. As more and more collection points are added in buildings or standalone collection points, their location, fill capacity and other important information may be displayed in the app for user/participants to view.

The collections and sorting stations have sufficient electronic hardware, firmware and software user interface to assist the user participant in separating their homogeneous recyclable materials into the respective collection bins. In a high rise apartment or office building, this may begin with a user interface which is connected to a network to report any recorded transactions of discarded homogeneous or heterogeneous recyclable waste. There may be selections on a touch screen or membrane interface which send information to a “central control system” which is monitoring and controlling the separation of the discarded material. The participant will be required to either enter a pin code, RFID access tag or may use geofencing to determine user within proximity of said collection or sorting stations. Once verification of user/participant is complete, the user may make a selection of any genre' of recyclable waste they wish to discard. If they select any of the various homogeneous or heterogeneous options, the central control system sends back a request for confirmation of selection. The User participant will now scan electronically or visually enhanced bag or ID Tag to ensure the manual selection and tagged bag they wish to discard are synonymous with one another. Once determined the user selection to be a match, they the access portal controller sends information to a mechanical sorter which alters the path of the discarded material to a respective homogeneous or heterogeneous collection bin.

The transaction for the user/participant has now occurred and the central control system now sends confirmation to the user/participant app to (1) remove respective discarded tagged bag ID from their personal inventory and (2) to notify said user/participant of transaction completion. The user/participant task is now completed.

Each Bin is also tagged or electronically enhanced with “Geolocation” and a sensor on the “Sorter” sends capacity info to the central control system constantly monitoring each bin's fill capacity. When the fill capacity reaches full on any bin, a notification is sent out to “Logistics” to enter the bin's geolocation and homogeneous genre. Logistics now has received information to pick up said electronically enhanced bin.

In a remote sorting station there may be several access portals in which to discard homogeneous recyclable waste whereby each access portal will have a respective electronically enhanced collection container which is monitored for capacity, geolocation and genre' of homogeneous or heterogeneous waste. The remote system may or may not require a scanning of the bag for verification however certain user ID requirements for discarding waste may be required to access the recycling portal leading to the respective electronically enhanced collection container. The remote system may also contain a central control system which connects to a network to notify logistics of geolocation, full containers and homogeneous or heterogeneous recyclable waste.

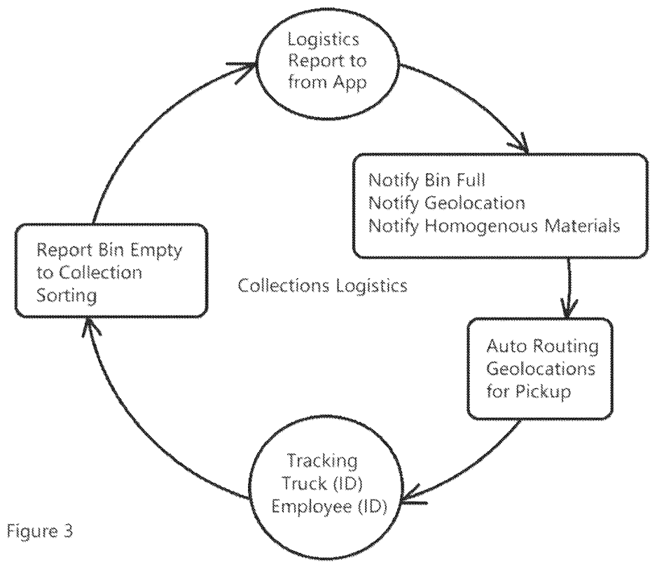

### Logistics: (FIG. 3)

After geolocations of multiple homogeneous genre' of bins are reported to the app, a setting or procedure call generates a routing map that outlines an efficient route for recyclable waste management pickup drivers to pick up selected homogeneous genre' or heterogeneous genre' of recyclable waste. For instance if the homogeneous recyclable collection bin is filled with plastic, then the genre is plastic and a “plastic pickup route” is generated of a plurality of geolocations. This information is sent to the pickup waste management trucks which contain a Truck ID and personnel ID. Each personnel inside the truck also have a membership in which they are an active participant in the transportation of the recyclable materials. Each personnel may post comments or other information of any issues in the recycling system. The app will be capable of tracking the geolocation truck ID as it moves through the route and update the bin capacity as empty as it completes each location task.

Once the truck ID reaches the geolocation of a homogeneous or heterogeneous bin that was reported to be full, a geofencing element will automatically remove the Bin from Bin Full status and as collection of each bin is completed, the efficiency of the route, personnel and collections will all be recorded whereby the relational database may use this information to improve future recycling transactions.

When the waste management truck ID is full, it now moves to the processing plant. So the routing begins with a first geolocation, moves efficiently to each location in the auto-route until last geolocation in the route is completed and a final geolocation of a processing plant which corresponds to the homogeneous or heterogeneous recyclable waste contained in the waste management truck. When the waste management truck enters the geolocation of the processing plant, it empties its contents and now the task of the waste management pickup and delivery system is complete and the tagged bags now enter the Processing Plant.

We recognize the logistics may choose to use an intermediary location to accrue larger amounts of tagged bags of homogeneous or heterogeneous recyclable waste with respective accumulation in higher quantity waste containers which may act to collect larger amounts of recyclable waste before distributing said homogeneous or heterogeneous recyclable waste to a processing plant thereby making the process of logistics for collections more efficient for the pickup and delivery elements.

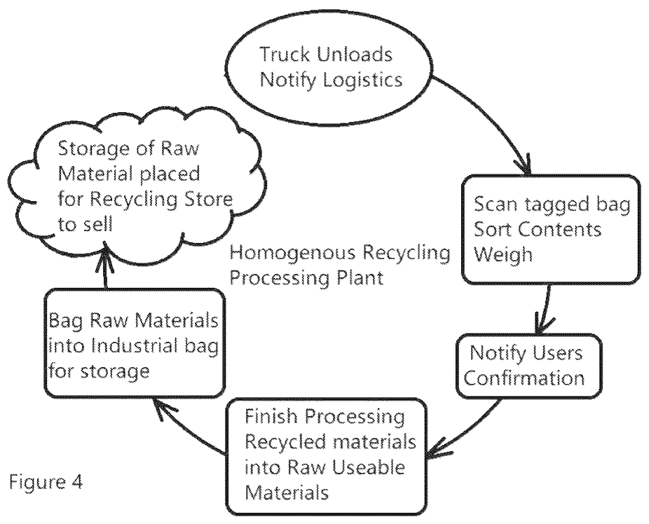

### Processing Plant: (FIG. 4)

Now the waste management truck has completed its task and delivered the homogeneous or heterogeneous recyclable waste to the processing center. The Processing Center receives each of the electronically and visually enhanced tagged bags where they are scanned as they enter, contents sorted and weighed. After the electronically and visually enhanced tagged bag is scanned, a notification is now sent to the respective user/participant confirmation of reception and updates their app of participation for them to view their recycling effort progress. Each processing plant now processes the materials into raw recycled materials and is bagged and tagged for unique ID representing the quantification, quality and genre' of recyclable homogeneous material.

Any material that is not recyclable may be utilized as energy by pyrolysis fusion feedback. This provides a low toxic energy generating element whereby the app tracks useable and non-useable recycling waste. However it is well known the residue of pyrolysis fusion waste may also be utilized in such things as concrete or other carbon reliant consumer products thereby making the energy generating waste a useable recyclable heterogeneous compound.

The processed materials are now tagged and bagged in their respective containment element and now are scanned and recorded as “Available” in the app store where a “Online Sales Market” sells these raw materials to manufacturers to augment virgin materials used to make consumer goods. These listings are viewable by market participants who also are a component of the relational database who participate by purchasing recyclable raw materials and utilizing them in their production process.

The goal is to reverse the augmentation percentage whereby currently according to the EPA, of the 267.8 million tons of municipal solid waste generated by Americans in 2017, a little more than ⅓ or only 94.2 million tons were recycled or composted. Sixty-six percent of discarded paper and cardboard was recycled, 27 percent of glass, and 8 percent of plastics were recycled. Plastics is one of the most pollutant recyclable materials today and utilizing an efficient system for participating, tracking and rewarding, 92% of virgin plastics infused with 8% of recycled plastics can reverse where 92% of recycled plastics and 8% of virgin plastics will be infused in the production process thereby reducing global waste of plastics in our oceans and waterways.

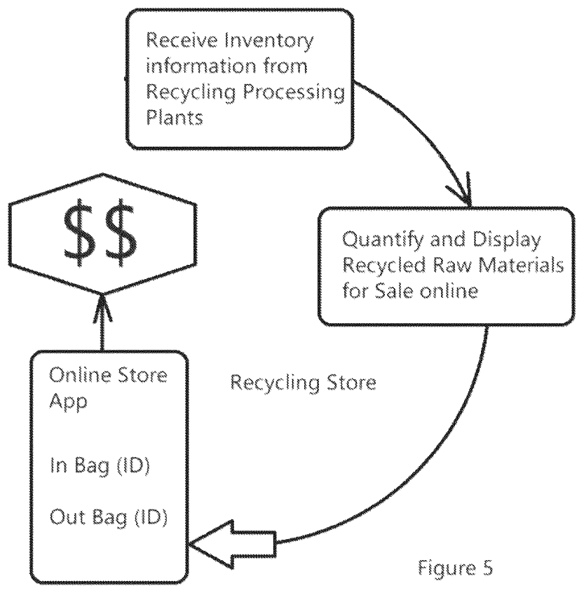

### Market Store: (FIG. 5)

The market store is an online homogeneous recyclable goods buyer's app that shows postings of each of the processing plant's homogeneous raw materials in their storage that is available for sale. These raw recycled materials can either be purchased or a bid placed for purchase. Both way, the raw recycled material purchase will be confirmed in the app to the buyer and the ID tagged industrial bag of raw recycled material or plurality of ID tagged raw recycled material will be removed from the market store and readied for shipping to the buyer.

Each element of transactions will be recorded in the app to display the buyer's participation level, quantity and homogeneous genre of recycled raw material used for future viewing or real-time monitoring. The online purchase made in the market will now record the transactions and handle the revenue contributed by the first purchasing party (Buyer) and the second recycled raw material supplier party (Seller) so the assurance of each transaction is handled by the logistics of the app and tracking information of the recycled raw material is traced from seller to buyer's location. Once the purchased recycled raw material arrives at the buyer's location, the processing plant is notified in the app and their part of the recycling participation is completed after receiving financial compensation for said transaction.

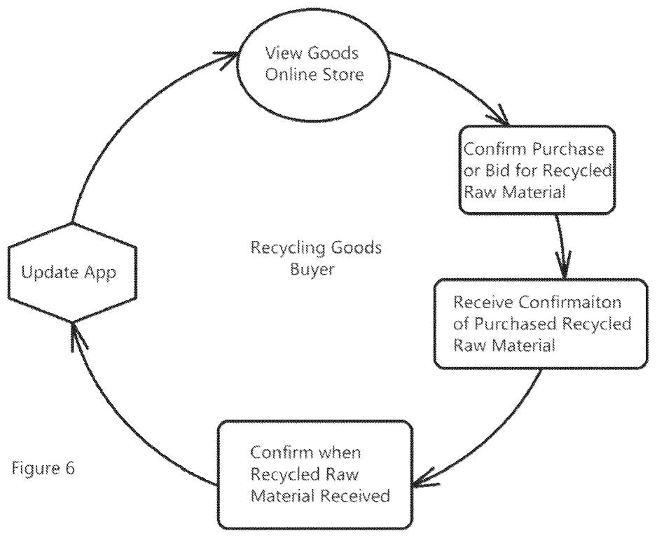

### Recycling Goods Buyer: (FIG. 6)

The buyer may be any one of several entities such as “Speculators in the Market” or manufacturers who wish to participate in the purchase of homogeneous recycled raw materials for producing consumer goods and wears. A part of the market app is located in the relational database which ties the user/participants, investors or manufacturers to the market store where anyone can buy or bid on homogeneous raw recycled material. A speculator may wish to buy up recycled materials and resell these items in the app or the homogeneous raw material may be purchased by manufacturers who use these materials in their production process.

The buyer enters the market section of the app where there is a listing or search bar to look for specific homogeneous recycled raw material up for sale. Once they find the respective listing, they may place a bid or purchase the recycled raw material. After the purchase, the financial compensation will be held in escrow and they will receive confirmation of the transaction in the app and now await arrival of their recycled raw material. There may be options for “Co-location” of said recycled raw material as well depending on the vendor and storage options. If the buyer selects to have the material sent to their location, the app geolocation is updated and they may track their recycled raw materials to their location. Once received, the app is updated in the store and a notification of reception of recycled raw material is sent to the seller, financial compensations are released from escrow and then the transaction is completed. The app is now updated to reflect a completed transaction.

Now if the buyer is a manufacturer, they may now receive the recycled raw material and infuse said recycled raw material into their manufacturing process thereby introducing what was once recycled waste into consumer products. These consumer products will enter the market where user/participants may purchase recycled products. This may include a sticker or QR code where once purchased, information about the purchase shows in the user/participants app showing their reintroduction of recycled goods they use as well. As a whole, the entire community in the relational database may view their individual participation, contribution and reward or view the community as a whole. Each participant may choose to congregate in groups and each group may be able to view their participation vs other groups or compare their efforts against the entire relational database of other recycling participants.

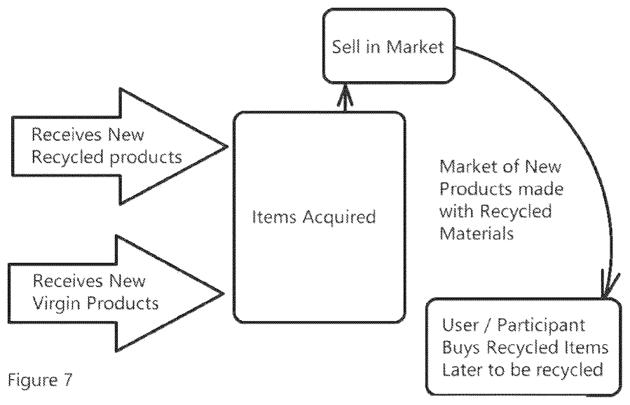

### Market: (FIG. 7)

The market is where items that are manufactured from recycled waste are sold to others who may or may not participate with other user/participants in the recycling relational database. However those who purchase items may be able to scan said purchase items, utilize rewards or other coupons to accrue recycled items being sold in the recycling community. These recycled items may also be recycled once used and no longer useable by said user/participant where the cycle begins over again.

There are several recycled goods available to user/participants such as;
Aluminum cans
Car bumpers
Carpeting
Cereal boxes
Comic books
Egg cartons
Glass containers
Laundry detergent bottles
Motor oil
Construction Nails
Newspapers
Paper towels
Steel products
Trash bags
Electronics
Clothes
Iron/Steel
Concrete
Plastic Containers
Shoes
Glasses
Pots n Pans
Rubber

Any of these recyclable materials can be reintroduced back into the market and made into consumer products for reuse. Once proof of purchase for recycled transaction occurs which may be auto-generated after purchase transaction, the user/participant may scan the recycled consumer item which reenters the item into the relational database as a recycled item that came from the recycling cycle of the proposed app.

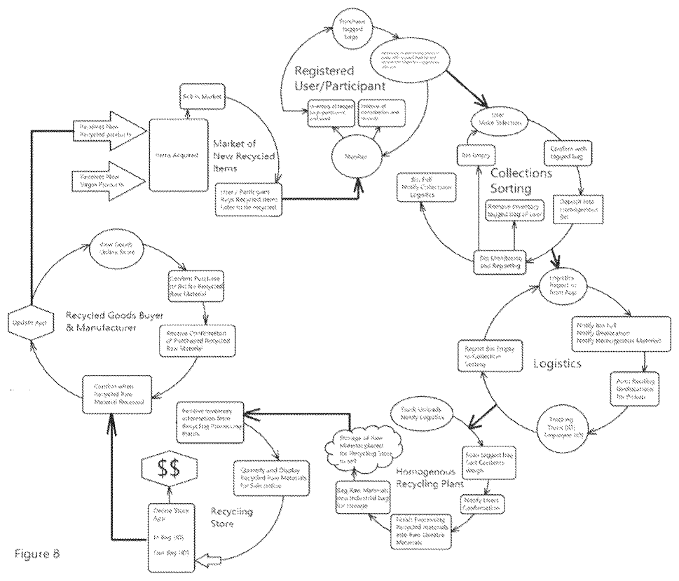

### Recycling Life Cycle Flow Chart: (FIG. 8)

A candidate for user/participant in recycling joins the community through an online app and becomes a member of said recycling community where recycling options are at their disposal to efficiently participate, track and monitor their contributions to the recycling community. Among these options are purchasing of recycling tagged bags for efficient tracking of homogeneous recycled waste or online markets with recycled consumer goods for sale in the app's online consumer market store.

The recycled homogeneous waste begins its journey when the user/participant discards their waste in a pre-sorting station. The pre-sorting station may be located in a building or at a remote location, each one with their respective security options sufficient to allow access to the sorting portal that leads to discarding the homogeneous or heterogeneous recyclable waste into a respective electronically enhanced waste container or bin. The said electronically enhanced waste container may report geolocation, full capacity status and homogeneous or heterogeneous genre' of recyclable waste to a logistics component in the app. This auto generates an efficient route mapping for efficient pickup and delivery. The said auto generated routing map is then sent to a recycling pickup and delivery service with Truck ID and Personnel ID for each pickup and delivery participant. The said Truck ID and Personnel ID are tracked in the app to determine geolocation and participation efficiency and each geolocation of said electronically enhanced recyclable waste containers utilizes geofencing and updates the said electronically enhanced recyclable waste containers to be empty. Once route is completed in the auto generated map, the homogeneous or heterogeneous recyclable waste is sent to a respective processing plant for scanning, sorting and weighing of received tagged bags of homogeneous or heterogeneous recyclable waste which a notification is generated and sent to user/participant of said participation and confirmation. The processing plant now processes the received goods after scanning, sorting and weighing whereby said homogeneous recyclable goods are determined to be recyclable or non-recyclable waste. They are separated and the recyclable waste is converted into raw reusable material and the non-recyclable waste is incinerated and converted into energy through pyrolysis fusion feedback to aid in the reduction of toxins and waste that will be placed back into the environment. The byproduct of the pyrolysis fusion can be converted into filler for concrete, rubber or other useable consumer materials. The useable recyclable waste is converted into raw material and tagged in an industrial bag for storage. Once the bag is placed in storage and the tag is generated and associated with said bag of raw recyclable material, the goods are placed in an online store for sale for a manufacturer or speculator to purchase in the sales store located within the app.

The recycling store is a component in the app that places the raw recyclable materials online in a buyer's market where transactions ensure the proper and secure distribution of said raw recycled materials. After the processing plant places the tagged bag into storage, a field in the relational database is filled and displayed as “Available” with Weight, Location, Homogeneous Genre' and perhaps Quality and Quantity as well. This information is laid out in an easy to read format so that buyers can index their searches for the specific recycled raw materials they are looking for.

The app tracks the inflow and outflow of recyclable raw materials from the processing plant to the buyers and shows when purchased raw recycled materials leave the supplier and arrive at the buyer's location. This information is logged and updated after each step of the transaction to ensure efficiency of recycling sales operations.

The buyer is also an active user/participant in the app whereby they have exclusive access to the store to purchase recyclable raw materials either through market speculation and trending data or via direct purchase by manufacturers for manufacturing consumer goods from said homogeneous raw recyclable materials. A buyer active user/participant may view the Recycling Store and see the various containers of homogeneous raw recycled material for sale and may either purchase or bid on the items they wish to purchase. After the purchase whether it was through bid or direct purchase, the items will be removed from the “For Sale” list in the relational database and now assigned to a buyer. Tracking the item in the app will show the geolocation of the purchased homogeneous recycled raw material from the supplier, while in transit and when it arrives at the buyer's location. Once arrived at the buyer's location, the app is updated and the transaction is completed for the supplier.

The buyer is more than likely a manufacturer regardless if the homogeneous recycled raw material was purchased by a speculator. The manufacturer is the user of the homogeneous recycled raw materials which is infused in the manufacturing process to manufacture consumer goods. These goods manufactured with recycled raw materials will now enter the market place which will also have a place in the app to sell to user/participants. Each product ready for market will have a new tag which when purchased and shipped to the user/participant can be scanned by said user/participant to further update their contribution section of their app to display in their group or community their individual contributions to recycling, or group contribution update to compare groups and so on.

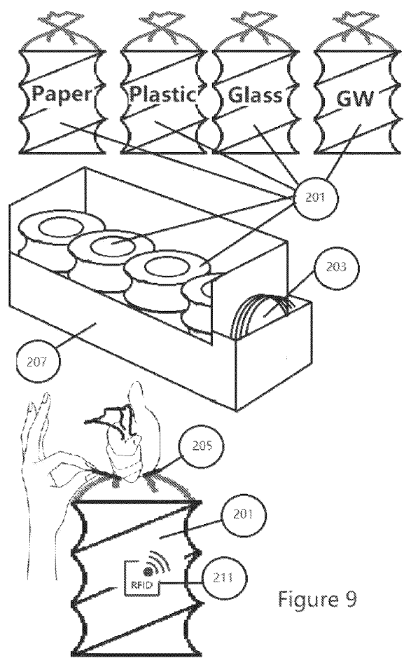

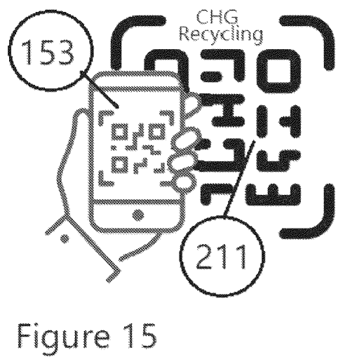

FIG. 9 shows a group of homogeneous (Paper, Plastic & Glass) and one heterogeneous (GW General Waste) recyclable waste receptacles (201) which fit in a containment element (207) having a compartment to hold other tagged recyclable waste containment elements (203). The homogeneous recyclable waste container element (201) having a scan able electronic element such as QR Code or RFID tag (211 FIG. 9 and FIG. 15) that is utilized to track said homogeneous recyclable waste container through the recycling cycle describe in FIG. 8.

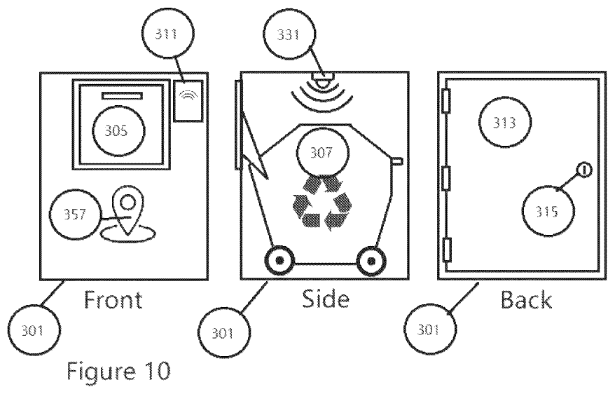

FIG. 10 shows a front view, side view and back view of a remote homogeneous recyclable waste sorting container (301) where front view shows a secure access portal (305) which requires an access security element (311) for proper access of said remote homogeneous recyclable waste container (301). The face also shows a “Geolocation tag” (357) which is used for geofencing, notification services to logistics and mapping services to user participants for geolocation of said homogeneous recyclable waste container. Side view shows a side of a portable homogeneous recyclable waste container (307) which collects the homogeneous recyclable waste from the user/participant and a bin full sensor (331) which detects when said portable homogeneous recyclable waste container is full thereby notifying logistics of geolocation from geolocation element (357). Back view shows a portable homogeneous recyclable waste container (307) access door (313) which can be secured with a lock (315) to prevent unauthorized access.

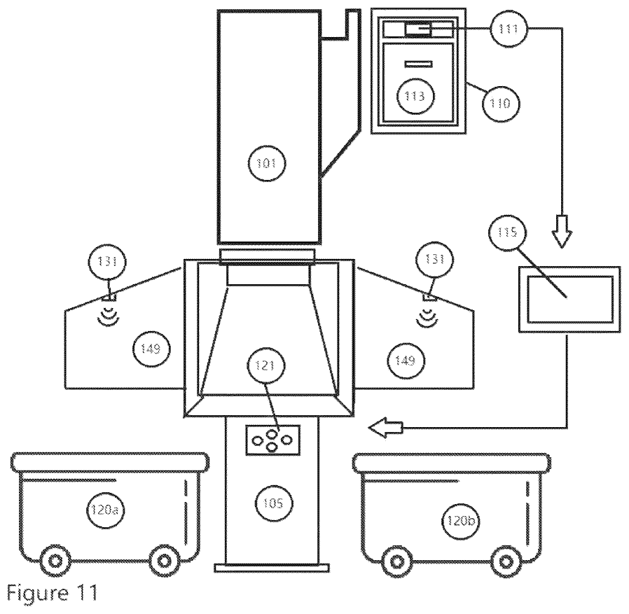

FIG. 11 shows gravity chute (101) called a “branch” with a front view of an access portal (110) with an access door (113) which has a digital electronic user interface security element (111) that has selection options for the user/participant to discard their homogeneous or heterogeneous recyclable waste down the gravity chute (101) and onto the strike plate of the rotational diverter (105) which directs the homogeneous or heterogeneous recyclable waste into the respective homogeneous or heterogeneous recyclable container (120a, 120b) respectively. A set of bin full sensors (131) are mounted on a splash guard (149) which direct their focus on the homogeneous and heterogeneous recyclable waste bin (120a, 120b) capacity levels. This information is fed to a central control system (115) which is connected to a network to notify logistics. Said diverter/sorter element (105) containing sufficient hardware, firmware and user interface (121) to control said rotation commands sent by the user/participant utilizing the floor user interface (111) which contains sufficient firmware and software to guide said user/participant in selection and confirmation of homogeneous and heterogeneous waste options.

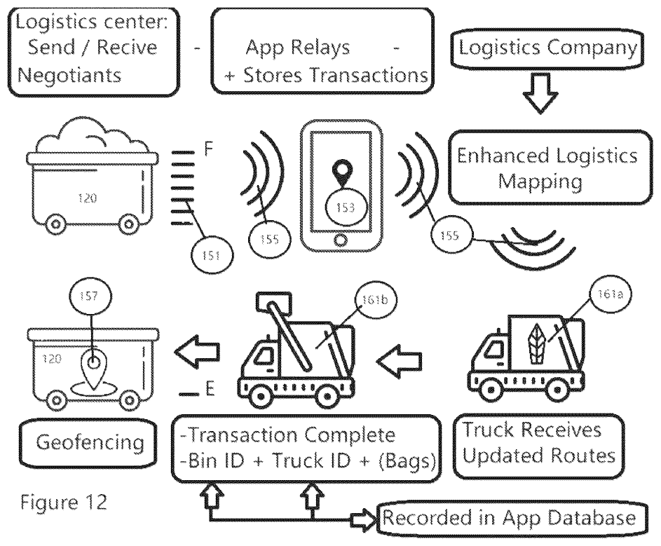

FIG. 12 shows recycling sorting electronically enhanced homogeneous recyclable waste containment elements (120) which sensors determine the fill capacity (151) that is relayed via network (155) to a logistics component in an app (153) where said logistic component contain homogeneous or heterogeneous recyclable waste information, geolocation, time, date and weight. This information is relayed via network (155) to an enhanced logistic mapping component that generates a routing map and is sent to a recyclable waste pickup and delivery service element (161a) which drives to location to empty said homogeneous or heterogeneous recyclable waste containment element (120) which contains a geofencing element (157) that determines the recyclable waste pickup and delivery personnel (161b) has completed their homogeneous or heterogeneous recyclable waste pickup task. The recyclable waste containment element (120) is now empty and reports to the system via sensor the fill capacity (151) reflecting empty.

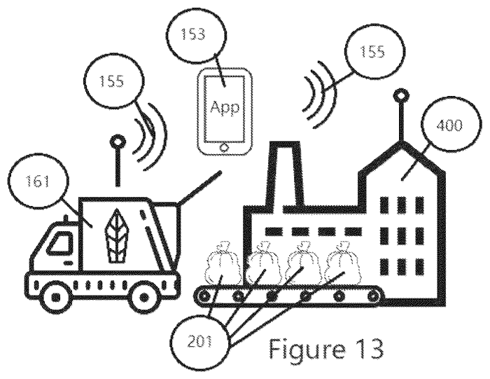

FIG. 13, shows a recyclable waste pickup and delivery service (161) unloading tagged bags (201) onto a conveyor at a recycling plant (400) which processes said recyclable material. Said recyclable waste delivery services (161) sends notification over a network to specify their task of delivery to said recyclable waste processing plant (400) and the app (153) is updated to reflect completion of delivery service.

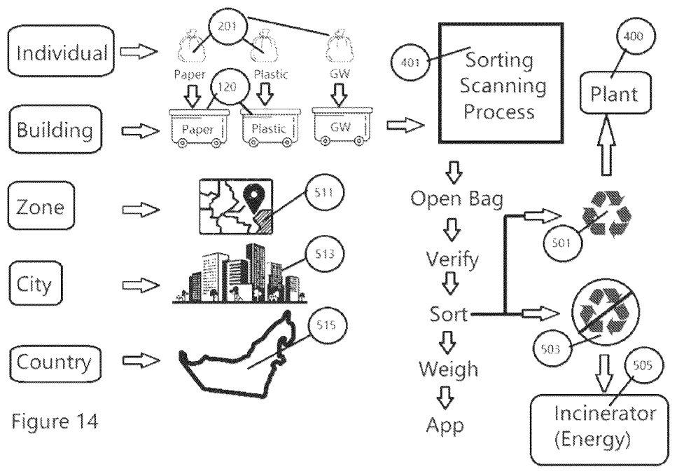

FIG. 14 shows a first user/participant identified as “individual” who will be discarding a specific genre of homogeneous waste (201) in a sorting system which contains electronically enhanced recycling containment elements (120) where paper goes to paper containment bin, plastic goes to plastic bin and general waste goes to GW bin. Once electronically enhanced recycling containment elements are full, they notify logistics and are sent for sorting and processing (401) to a sorting and processing plant (400) where a sorting process includes opening the tagged bag, verifying contents and sorting said contents into useable recyclable waste (501) and non-useable recycling waste (503) whereby said useable recyclable waste is processed into recycled raw material and non-useable recyclable waste is incinerated using a pyrolysis fusion feedback system and converted to energy (505).

FIG. 14 also shows a zoning of the mapping component (511) which will show in the app to identify regions with best practice of recycling participation, a specific city (513) and a country (515) whereby user/participants may open the app and view recycling progress in their area.

FIG. 15 shows a tag (211) which may be an RIFD, NFC, QR Code or like being scanned by the app (153) to register recycled elements used in recycling, consumer goods made from recycling materials, registration of goods or used in the network to identify proximity, geolocation, network ID, access or control and other aspects of the recycling process cycle.

1. A process of recycling controlled by a recycling social media application which utilizes user/participants and controls, monitors and reports information about recyclable waste from starting point of discarding recyclable homogeneous or heterogeneous recyclable waste into presorting elements that contain electronically enhanced recyclable waste containment elements which notify specific participants of geolocation, recyclable genre' and weight for pickup and delivery to a processing plant whereby said social media application monitors and reports every aspect of the recyclable waste to consumer recycled goods.

2. The process in claim 1 where recycling social media application further comprises of a user interface for signup to garner user/participants who will be the collectors and discarders of recyclable waste.

3. The process in claim 1 where recycling social media application further comprises of a delivery service participant interface for signup to act as the transport mechanism of the recyclable waste from a first collection/presorting location.

4. The process in claim 2 where user participants may utilize traceable tagged electronically enhanced homogeneous or heterogeneous bags.

5. The process in claim 4 where said traceable tagged electronically enhanced homogeneous or heterogeneous bags are recorded at a presorting location and placed in a respective electronically enhanced container and reported to a relational database.

6. The process in claim 5 where homogeneous and heterogeneous recyclable waste presorting elements notifies said user/participants recycling social media application of personal inventory changes due to the discarding of tagged tracking bags found in said relational database.

7. The process in claim 1 where said recyclable waste containment elements utilize network connected sensors to notify a logistics component of the app using a relational database.

8. The process in claim 1 where enhanced recyclable waste containment elements have sufficient sensors to determine geolocation which is posted in a relational database.

9. The process in claim 7 where logistics component of the app auto-generates geolocation routing map from geolocation sensor data found in the relational database.

10. The process in claim 9 to update and notify participants utilizing said recycling social media application through a network the progress of recyclable waste pickup and delivery service through a relational database.

11. The process in claim 10 of utilizing information from the recycling social media application relational database to improve efficiency of recycling through monitoring, tracking performance and publishing results for said members of the social media to view.

12. The process in claim 1 where participants in the geolocation are processing plant personnel who process recyclable waste into recycled raw materials and in turn notify users/participants of verified reception of tagged recycled bag contents.

13. The process in claim 1 where said recycling social media application electronically validates every step of the recycling process reporting information to a relational database.

14. The process in claim 13 where electronic validation includes geolocations, times, dates, genre of recycled waste and weight.

15. The process in claim 13 where electronic validation of recycling data is published in a relational database to reflect the geographic relationship of homogeneous and heterogeneous recyclable waste showing routing and tracing of recycled materials.

16. A recycling social media application which offers user/participants the ability to monitor their participation in community recycling using a network of electronically enhanced collection, mobilization, processing and purchasing of recycled consumer goods.

17. The recycling social media application of claim 16 which connects user/participants to a network of recycling hardware, locations and sorting stations.

18. The recycling social media application of claim 16 further comprising of a logistics which interconnects electronically enhanced collection and pre-sorting hardware in a geolocation mapping app to aid in finding recyclable waste management locations.

19. The recycling social media application of claim 18 where logistics provides information of geolocation of recycle bins which are full in an efficient routing process.

20. The recycling social media application of claim 18 further comprising of time and date of pickup and time and date of delivery to a processing plant.

21. The recycling social media application of claim 18 further comprising of a genre' of recyclable waste in the form of a color coded pin drop representing geolocation coordinates on a digital map whereby said coordinates interconnect to form an efficient route for a specific genre of recyclable waste.

22. The recycling social media application of claim 18 further comprising of a corresponding processing plant that matches the genre' of recyclable waste being picked up at each reported geolocation.

23. The recycling social media application of claim 16 further comprising of notification services from the processing plant which uses a scanning element to determine the tagged bag origin and notifies said user of confirmation of received items and their level of contribution associated with said received items.

24. The recycling social media application of claim 16 which contains an online store to sell recyclable raw material that is generated by the processing plant to perspective online buyers.

25. The recycling social media application of claim 24 where recycling social media application further comprises of elements which assure proper and secure transport from recycled raw materials provider to buyer.

26. The recycling social media application of claim 24 where recycling social media application further contains secure financial transaction elements to assure each party who is participating in the exchange of recyclable raw materials sends and receives said purchased material.

27. The recycling social media application of claim 26 where recycling social media application secure financial transaction covers both buyer and seller of recycled raw materials.

28. The recycling social media application of claim 16, wherein the recycling social media application to-tracks purchases of recycled consumer goods through an online store which were part of the same participant's recycling cycle they contributed to.

29. The recycling social media application of claim 18 whereby said recycling app mapping component includes routing individual pickup and delivery of recyclable waste to be diverted to an intermediary geolocation used to congregate larger amounts of recyclable waste and updated to said app relational database.

30. The recycling social media application of claim 29 where said recycling app relational database includes quantitative relationships corresponding to accrual of said homogeneous or heterogeneous recyclable waste.

31. The recycling social media application of claim 29 where said recycling app relational database includes qualitative relationships corresponding to accrual of said homogeneous or heterogeneous recyclable waste.

32. The recycling social media application of claim 30 where said quantitative relationship data is recorded in a relational database and displayed in said recycling app for user participants to view.

33. The recycling social media application of claim 31 where said qualitative relationship data is recorded in a relational database in said recycling app for user participants to view.

34. The recycling social media application of claim 29 where said recycling app geolocation is recorded and displayed in a relational database utilizing a pin drop icon whose color represents respective accrued homogeneous or heterogeneous waste elements.
